(19) United States
(12) Patent Application Publication
(10) Pub. No.: US 2024/0251076 A1
(43) Pub. Date: Jul. 25, 2024

(54) ELECTRONIC DEVICE AND METHOD OF INTRA PREDICTION

(71) Applicant: Industrial Technology Research Institute, Hsinchu (TW)

(72) Inventors: Sheng-Po Wang, Taoyuan City (TW); Ching-Chieh Lin, Taipei City (TW); Chun-Lung Lin, Taipei City (TW)

(73) Assignee: Industrial Technology Research Institute, Hsinchu (TW)

(21) Appl. No.: 18/496,910

(22) Filed: Oct. 29, 2023

Related U.S. Application Data
(60) Provisional application No. 63/422,431, filed on Nov. 4, 2022.

(30) Foreign Application Priority Data
Oct. 24, 2023 (TW) 112140564

(51) Int. Cl. H04N 19/11; H04N 19/105; H04N 19/119; H04N 19/176

(52) U.S. Cl. CPC H04N 19/11; H04N 19/105; H04N 19/119; H04N 19/176

(57) ABSTRACT

An electronic device and a method of intra prediction. The method includes: a first reference area adjacent to a first target image block is obtained from a reference image block, and the first reference area includes multiple first reference samples corresponding to a first direction; an intra mode of the first target image block is determined according to the first reference samples; and the intra mode is outputted.

### CROSS REFERENCE TO RELATED APPLICATION

This application claims the priority benefit of U.S. provisional application Ser. No. 63/422,431, filed on Nov. 4, 2022, and Taiwan application serial no. 112140564, filed on Oct. 24, 2023. The entirety of each of the above-mentioned patent applications is hereby incorporated by reference herein and made a part of this specification.

### TECHNICAL FIELD

The disclosure relates to an image processing technology, and particularly to an electronic device and a method of intra prediction.

### BACKGROUND

The conventional multimedia service model relies on cloud servers to provide compressed image data to user equipment. Image processing operations configured for image data are performed by the cloud servers, so the computing burden on the user equipment is not heavy. However, the image processing operations of emerging multimedia service models (such as the Internet of Things or self-media services) need to be performed by the user equipment. Therefore, the transmission efficiency of image data is limited by the computing power of the user equipment. In view of this, how to design an image encoder with low complexity and low energy consumption is one of the important topics in the technical field.

### SUMMARY

The disclosure provides an electronic device and a method of intra prediction, which may perform encoding for images with a relatively low computational load.

A method of intra prediction of the disclosure includes: a first reference area adjacent to a first target image block is obtained from a reference image block, and the first reference area includes multiple first reference samples corresponding to a first direction; an intra mode of the first target image block is determined according to the first reference samples; and the intra mode is outputted.

In an embodiment of the disclosure, the above step of determining the intra mode of the first target image block according to the first reference samples includes: a convolution operation is performed on the first reference samples according to a first convolution mask of a filter to obtain a first set; a convolution operation is performed on the first reference samples according to a second convolution mask of the filter to obtain a second set; and the intra mode of the first target image block is determined according to the first set and the second set.

In an embodiment of the disclosure, the above step of determining the intra mode according to the first set and the second set includes: multiple intensity sums respectively corresponding to multiple angles are determined according to the first set and the second set; at least one angle is selected from the angles according to the intensity sums; and the intra mode is obtained from a lookup table according to the at least one angle.

In an embodiment of the disclosure, the above first set includes a first value and the second set includes a second value corresponding to the first value, and the step of determining the intensity sums respectively corresponding to the angles according to the first set and the second set includes: a first intensity is calculated according to the first value and the second value; the first intensity is determined to correspond to a first angle among the angles according to a ratio of the second value to the first value; and in response to at least one intensity including the first intensity corresponding to the first angle, a first intensity sum corresponding to the first angle is calculated according to the at least one intensity.

In an embodiment of the disclosure, the above step of selecting the at least one angle from the angles according to the intensity sums includes: in response to at least one intensity sum corresponding to the at least one angle being greater than a second intensity sum corresponding to a second angle among the angles, the at least one angle is selected from the at least one angle and the second angle.

In an embodiment of the disclosure, the above at least one angle includes a first angle corresponding to a first intensity sum and a second angle corresponding to a second intensity sum, and the step of obtaining the intra mode from the lookup table according to the at least one angle includes: a third angle is calculated according to a first weight corresponding to the first intensity sum, a second weight corresponding to the second intensity sum, the first angle, and the second angle; and the intra mode is obtained from the lookup table according to the third angle.

In an embodiment of the disclosure, a difference between the above first intensity sum and the second intensity sum is less than a threshold.

In an embodiment of the disclosure, the above method further includes: a second reference area adjacent to a second target image block is obtained from the reference image block, and the second reference area includes multiple second reference samples corresponding to a second direction; a convolution operation is performed on the second reference samples according to a filter to obtain multiple intensities; and the second target image block is divided according to the intensities to obtain the first target image block.

In an embodiment of the disclosure, the above intensities include a first intensity and a second intensity respectively corresponding to two adjacent reference samples, and the step of dividing the second target image block according to the intensities to obtain the first target image block includes: in response to a difference between the first intensity and the second intensity being greater than a threshold, a split point is set according to the two adjacent reference samples; and the second target image block is divided according to the split point to obtain the first target image block.

In an embodiment of the disclosure, the above filter includes a directional feature detection filter, such as a Sobel filter.

In an embodiment of the disclosure, the above first reference area includes multiple second reference samples corresponding to a second direction, and the step of determining the intra mode of the first target image block includes: the intra mode of the first target image block is determined according to the first reference samples and the second reference samples.

In an embodiment of the disclosure, the above method further includes: the first target image block is predicted according to the intra mode, and the first target image block corresponds to an original image block; residuals between the original image block and the first target image block predicted are calculated; and the residuals are transmitted.

In an embodiment of the disclosure, the above method further includes: the first target image block is predicted according to the intra mode; residuals corresponding to the first target image block are received; and an original image block is reconstructed according to the first target image block predicted and the residuals.

In an embodiment of the disclosure, the above method further includes: in response to an image block having no adjacent reference samples, an average intensity of the image block is calculated; and the average intensity is transmitted.

In an embodiment of the disclosure, the above method further includes: an average intensity corresponding to an image block is received; and the image block is reconstructed according to the average intensity, and the image block has no adjacent reference samples.

In an embodiment of the disclosure, the above reference image block and the first target image block are included in the same frame.

In an embodiment of the disclosure, the above step of determining the intra mode of the first target image block according to the first reference samples includes: the first reference samples are inputted to a machine learning model to obtain the intra mode.

In an embodiment of the disclosure, the above method further includes: a second reference area adjacent to a second target image block is obtained from the reference image block, and the second reference area includes multiple second reference samples corresponding to a second direction; the second reference samples are inputted to a machine learning model to obtain the first target image block divided from the second target image block.

An electronic device of intra prediction of the disclosure includes a transceiver and a processor. The processor is coupled to the transceiver and configured for execution of: obtaining a first reference area adjacent to a first target image block from a reference image block, in which the first reference area includes multiple first reference samples corresponding to a first direction; determining an intra mode of the first target image block according to the first reference samples; and outputting the intra mode through the transceiver.

Based on the above, applying the encoder of the disclosure may meet the requirements of emerging multimedia services for product miniaturization, lightweight, low energy consumption, high transmission efficiency, and low latency.

### BRIEF DESCRIPTION OF THE DRAWINGS

FIG. 1 illustrates a schematic diagram of an electronic device of intra prediction according to an embodiment of the disclosure.

FIG. 2 illustrates a flowchart of intra prediction adapted for an encoder according to an embodiment of the disclosure.

FIG. 3 illustrates a schematic diagram of a target image block in a frame according to an embodiment of the disclosure.

FIG. 4 illustrates a schematic diagram of performing a convolution operation on reference areas according to an embodiment of the disclosure.

FIG. 5 illustrates a schematic diagram of dividing a target image block according to an embodiment of the disclosure.

FIG. 6 illustrates a histogram of intensity sums according to an embodiment of the disclosure.

FIG. 7 illustrates a schematic diagram of calculating an intra mode according to an embodiment of the disclosure.

FIG. 8 illustrates a flowchart of intra prediction adapted for a decoder according to an embodiment of the disclosure.

FIG. 9 illustrates a flowchart of a method of intra prediction according to an embodiment of the disclosure.

### DETAILED DESCRIPTION OF DISCLOSURED EMBODIMENTS

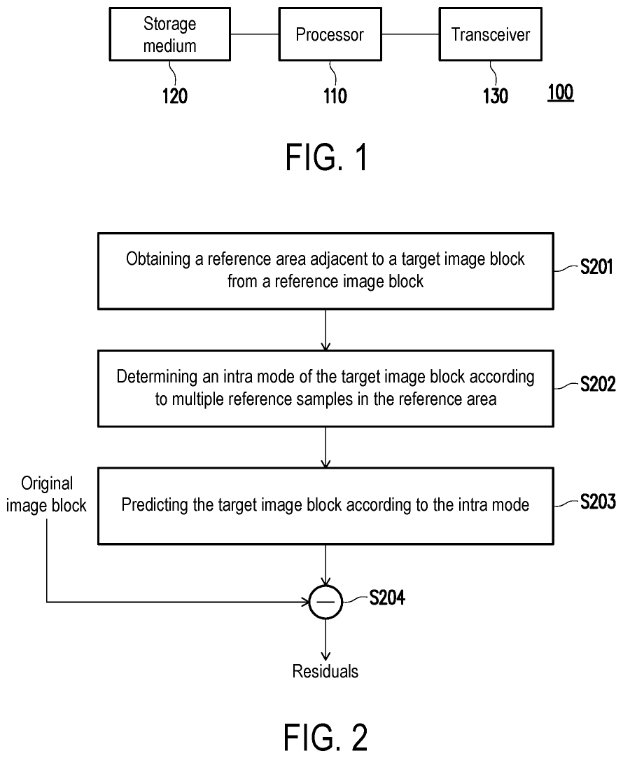

FIG. 1 illustrates a schematic diagram of an electronic device 100 of intra prediction according to an embodiment of the disclosure. The electronic device 100 may include a processor 110, a storage medium 120, and a transceiver 130. The electronic device 100 may be applied as an encoder or a decoder.

The processor 110 is, for example, a central processing unit (CPU), or other programmable general-purpose or special-purpose micro control unit (MCU), microprocessor, digital signal processor (DSP), programmable controller, application specific integrated circuit (ASIC), graphics processing unit (GPU), image signal processor (ISP), image processing unit (IPU), arithmetic logic unit (ALU), complex programmable logic device (CPLD), field programmable gate array (FPGA) or other similar elements or a combination of the above elements. The processor 110 may be coupled to the storage medium 120 and the transceiver 130, and access and execute multiple modules and various application programs stored in the storage medium 120.

The storage medium 120 is, for example, any type of fixed or removable random access memory (RAM), read-only memory (ROM), flash memory, hard disk drive (HDD), solid state drive (SSD) or similar elements or a combination of the above elements, configured to store multiple modules or various application programs that may be executed by the processor 110.

The transceiver 130 transmits or receives a signal in a wireless or wired manner. The transceiver 130 may further perform, for example, low noise amplification, impedance matching, mixing, up or down frequency conversion, filtering, amplification, and similar operations.

FIG. 2 illustrates a flowchart of intra prediction adapted for an encoder according to an embodiment of the disclosure, and the flowchart may be implemented by the electronic device 100 as shown in FIG. 1.

In step S201, the processor 110 may obtain a reference image block and obtain a reference area adjacent to a target image block from the reference image block. The reference image block is included in the same frame as the target image block and is adjacent to the target image block. The reference image block is a reconstructed image block, and the target image block is an image block that has not been reconstructed.

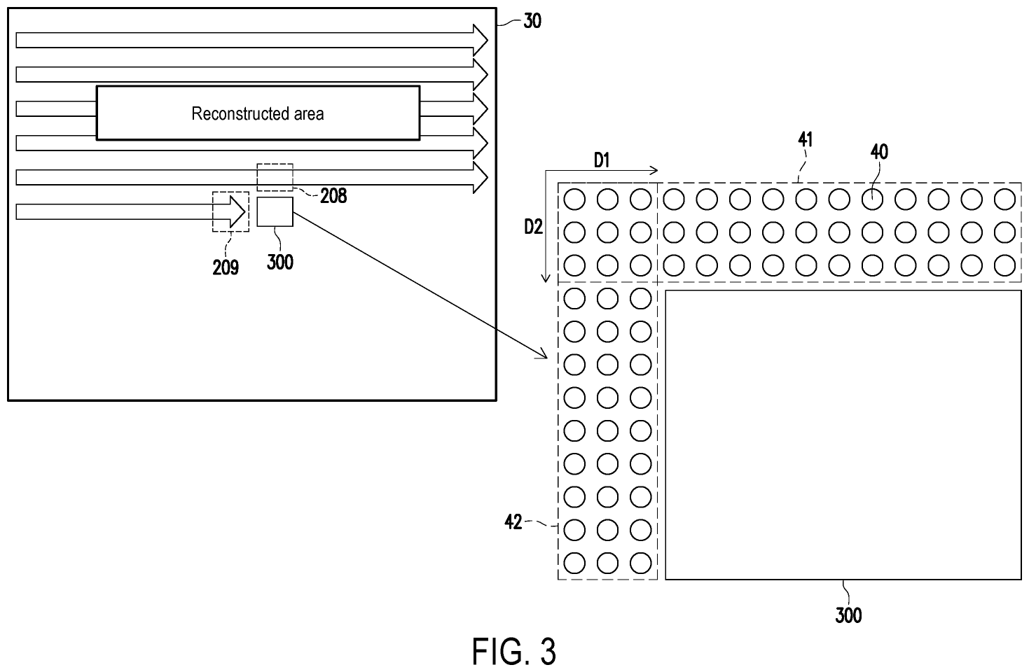

FIG. 3 illustrates a schematic diagram of a target image block 300 in a frame 30 according to an embodiment of the disclosure. In the following embodiment, it is assumed that the reconstruction order of the image blocks in the frame 30 is from left to right and from top to bottom. The reconstructed area in the frame 30 includes one or more reconstructed image blocks (i.e., image blocks that may be used as reference image blocks), and the non-reconstructed area in the frame 30 includes one or more unreconstructed image blocks. (i.e., image blocks that may be used as target image blocks).

If multiple sides of the target image block 300 are respectively adjacent to multiple reference image blocks, the processor 110 may select at least one image block from the reference image blocks, and obtain at least one reference area from the at least one image block. For example, the processor 110 may obtain a reference area 41 adjacent to the upper side of the target image block 300 from a reference image block (for example, a reference image block 208), and the reference area 41 may include multiple reference samples 40 corresponding to a direction D1 (for example, the right direction). In addition, the processor 110 may obtain a reference area 42 adjacent to the left side of the target image block 300 from another reference image block (for example, a reference image block 209), and the reference area 42 may include the reference samples 40 corresponding to a direction D2 (for example, the downward direction).

If merely one side of the target image block 300 is adjacent to a reference image block, the processor 110 may obtain a reference area from the reference image block. For example, if the target image block 300 is located at the left boundary of the frame 30 and merely the upper side of the target image block 300 is adjacent to the reference area 41, the processor 110 may obtain the reference area 41 adjacent to the upper side of the target image block 300 from the reference image block, and the reference area 41 may include the reference samples 40 corresponding to the direction D1. For another example, if the target image block 300 is located at the upper boundary of the frame 30 and merely the left side of the target image block 300 is adjacent to the reference area 42, the processor 110 may obtain the reference area 42 adjacent to the left side of the target image block 300 from the reference image block, and the reference area 42 may include the reference samples 40 corresponding to the direction D2.

If the target image block 300 is not adjacent to any reference image block (i.e., the target image block 300 has no adjacent reference samples), the processor 110 may not obtain the reference area for the target image block 300. The encoder may calculate an average intensity of the target image block 300 and transmit the average intensity to the decoder. The decoder may reconstruct the target image block 300 directly according to the average intensity. For example, if the target image block 300 is located in the upper left corner of the frame 30 and no image block in the frame 30 has been reconstructed, the processor 110 applied to the encoder may calculate the average intensity of the target image block 300 and transmit the average intensity to the decoder through the transceiver 130. On the other hand, the processor 110 applied to the decoder may receive the average intensity through the transceiver 130 and reconstruct the target image block 300 according to the average intensity.

Referring to FIG. 2 again, if the processor 110 obtains one or more reference areas corresponding to the target image block 300, in step S202, the processor 110 may determine an intra mode of the target image block 300 according to the reference samples 40 in the reference area. The intra mode may be configured to predict the target image block 300 to reconstruct the target image block 300 into an image block that is close to an original image block (i.e., ground truth).

In an embodiment, the processor 110 may input the reference area (for example, the reference area 41 or 42) of the target image block 300 to a trained machine learning model, so that the machine learning model outputs the intra mode corresponding to the target image block 300.

In an embodiment, the processor 110 may perform a convolution operation on the reference samples in the reference area according to a convolution mask of a filter to calculate multiple values, thereby obtaining a set composed of the values. The filter includes, for example, a Sobel filter and other directional feature detection filters.

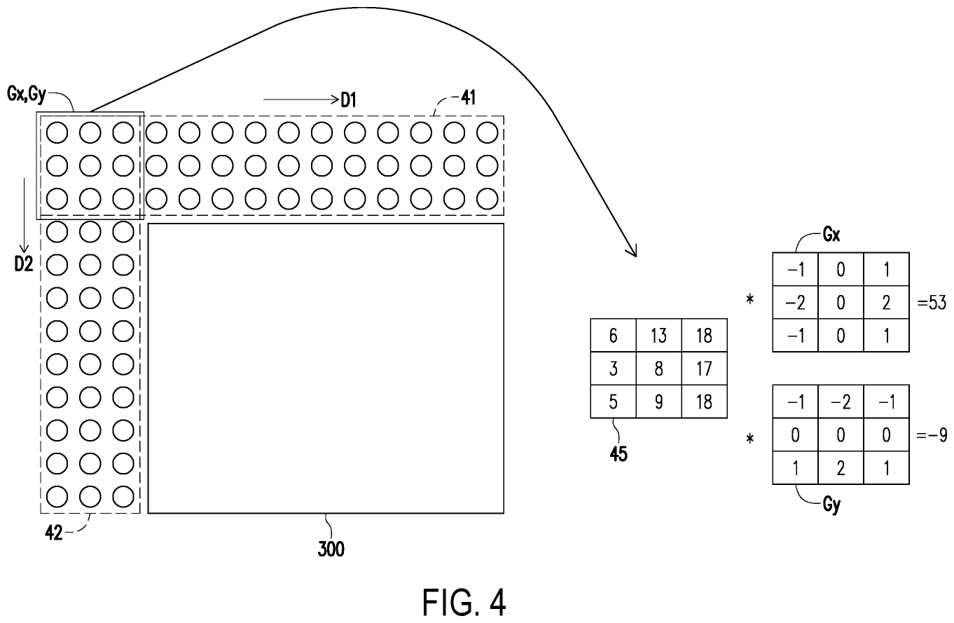

FIG. 4 illustrates a schematic diagram of performing a convolution operation on the reference areas 41 and 42 according to an embodiment of the disclosure. The Sobel filter may include a convolution mask Gx and a convolution mask Gy, and the minimum size of the convolution mask Gx or Gy may be 1*2 or 2*1. The processor 110 may perform a convolution operation on multiple reference samples in the reference area 41 according to the convolution mask Gx to obtain a first set={gx(1), gx(2), . . . , gx(n)} including multiple values. For example, the first set may include a result “gx(1)-53” of the convolution operation of a matrix 45 and the convolution mask Gx, and the matrix 45 is composed of the reference samples 40 in the reference area 41. On the other hand, the processor 110 may perform a convolution operation on multiple reference samples in the reference area 41 according to the convolution mask Gy to obtain a second set={gy(1), gy(2), . . . , gy(n)} including multiple values. For example, the second set may include a result “gy(1)=−9” of the convolution operation of the matrix 45 and the convolution mask Gy. In an embodiment, the processor 110 may calculate multiple angles and multiple intensities corresponding to the angles according to Formula (1) and Formula (2), where i is the index of elements in the first set and the second set, gx(i) represents the i-th element in the first set, gy(i) represents the i-th element in the second set, θ(i) represents the angle corresponding to the i-th element, and G(i) represents the intensity corresponding to the i-th element. Taking the matrix 45 as an example, the angle θ corresponding to the matrix 45 may be equal to (−9/53), and the intensity corresponding to the matrix 45 may be equal to |−9|+|53|=62.

$$θ ( i ) = \frac{\vert gy ( i ) \vert}{\vert gx ( i ) \vert} or θ ( i ) = {tan}^{- 1} \frac{\vert gy ( i ) \vert}{\vert gx ( i ) \vert} \qquad ( 1 )$$

$$G ( i ) = \vert gx ( i ) \vert + \vert gy ( i ) \vert \qquad ( 2 )$$

In an embodiment, the processor 110 may calculate multiple angles according to Formula (3), where i is the index of elements in the first set and the second set, gx(i) represents the i-th element in the first set, gy(i) represents the i-th element in the second set, θₜₘₚ(i) represents the value corresponding to the i-th element, and G(i) represents the intensity corresponding to the i-th element. After obtaining θₜₘₚ(i), the processor 110 may query the angle θ(i) corresponding to θₜₘₚ(i) according to a lookup table, and θ(i) represents the angle corresponding to the i-th element.

$${θ}_{tmp} ( i ) = \frac{\vert gy ( i ) \vert}{\vert gx ( i ) \vert} \qquad ( 3 )$$

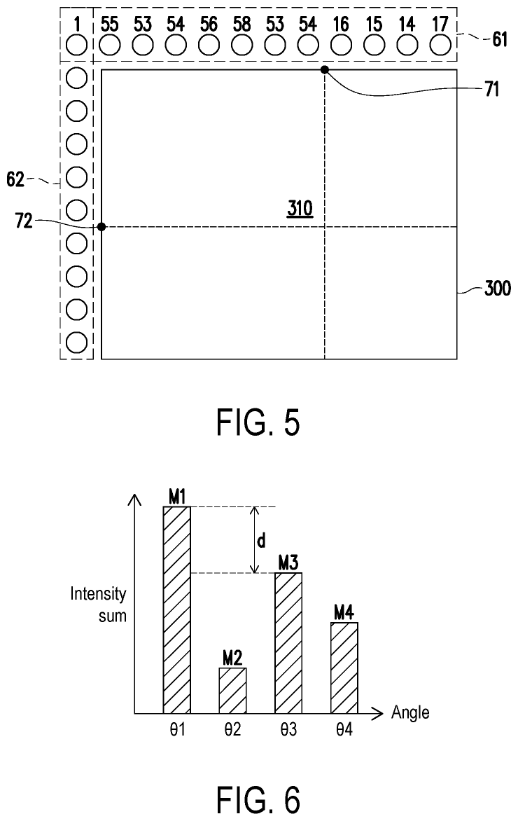

Multiple intensities calculated according to the reference area 41 may form an intensity set, such as an intensity set 61 shown in FIG. 5. On the other hand, the processor 110 may perform a convolution operation on the reference area 42 according to the convolution mask Gx and the convolution mask Gy in the same manner as the reference area 41, thereby obtaining an intensity set 62 corresponding to the reference area 42.

The processor 110 may determine the intra mode of the target image block 300 according to the intensity set 61 or the intensity set 62. In an embodiment, the processor 110 may first divide the target image block 300 into multiple sub-target image blocks according to the intensity set 61 or the intensity set 62, and determine an intra mode for each of the sub-target image blocks. Specifically, the intensity set may include two intensities respectively corresponding to two adjacent reference samples. If a difference between the two intensities is greater than a threshold, the processor 110 may set a split point according to the two adjacent reference samples, and divide the target image block 300 according to the split point. For example, the intensity set 61 includes two intensities “54” and “16” of two adjacent reference samples. Since the difference between the intensity “54” and the intensity “16” is greater than the threshold, the processor 110 may set a split point 71 according to the two adjacent reference samples, and divide the target image block 300 according to the split point 71. The processor 110 may set a split point 72 according to two adjacent reference samples in the intensity set 62 in the same manner, and divide the target image block 300 according to the split point 72. In an example, the processor 110 may divide a target image sub-block 310 from the target image block 300 according to the split point 71 and the split point 72. In an embodiment, the processor 110 may input multiple reference samples in the reference area 41 or the reference area 42 to a trained machine learning model to obtain the target image sub-block 310 divided from the target image block 300.

In order to determine the intra mode of the target image block 300, the processor 110 may determine multiple intensity sums respectively corresponding to multiple angles according to the intensity set 61 or the intensity set 62. The processor 110 may sum the intensities in the intensity set 61 or the intensity set 62 that correspond to the same angle to generate an intensity sum corresponding to the angle. For example, it is assumed that the intensity set 61={G₆₁(1), G₆₁(2), . . . , G₆₁(n)}={1, 55, . . . , 17}. If the angle θ₆₁(1) of the intensity G₆₁(1), the angle θ₆₁(2) of the intensity G₆₁(2), and the angle θ₆₁(n) of the intensity G₆₁(n) are all equal to θ1, the processor 110 may sum the intensities G₆₁(1), G₆₁(2), and G₆₁(n) to calculate an intensity sum M1=1+55+17=73 corresponding to θ1. As another example, it is assumed that the intensity set 61={G₆₁(1), G₆₁ (2), . . . , G₆₁(n)}={1, 55, . . . , 17} and the intensity set 62={G₆₂(1), G₆₂(2), . . . , G₆₂(n)}={1, 40, . . . , 12}. If the angle θ₆₁(n) of the intensity G₆₁(n), the angle θ₆₂(1) of the intensity G₆₂(1), and the angle θ₆₂(2) of the intensity G₆₂(2) are all equal to θ2, the processor 110 may sum the intensities G₆₁(n), G₆₂(1), and G₆₂(2) to calculate an intensity sum M2=1+1+40=42 corresponding to θ2.

The processor 110 may plot a histogram as shown in FIG. 6 according to multiple intensity sums respectively corresponding to multiple angles. For example, the histogram may represent that the intensity sum corresponding to the angle θ1 is M1, the intensity sum corresponding to the angle θ2 is M2, the intensity sum corresponding to the angle θ3 is M3, and the intensity sum corresponding to the angle θ4 is M4.

Referring to FIG. 6, the processor 110 may select one or more selected angles corresponding to a relatively large intensity sum from the angles, thereby determining the intra mode of the target image block 300 according to the one or more selected angles. In an embodiment, the processor 110 may select the angle corresponding to the maximum intensity sum from the angles. For example, the processor 110 may select the angle θ1 with the largest intensity sum M1 from the angles θ1 to 04. The processor 110 may select the intra mode corresponding to the angle θ1 from the lookup table as the intra mode of the target image block 300. The lookup table records multiple pairs of angles and intra modes with mapping relationships.

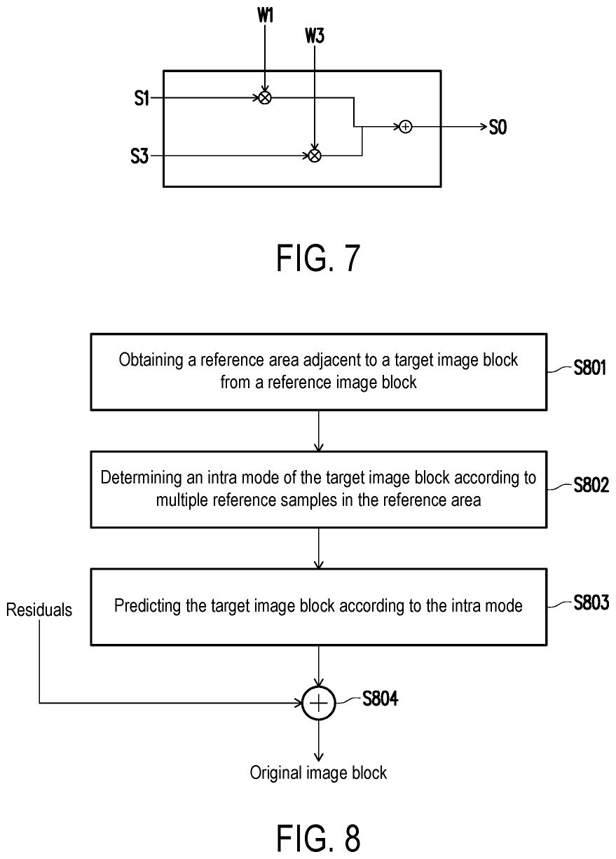

In an embodiment, the processor 110 may select multiple angles corresponding to a relatively large intensity sum from the angles. For example, the processor 110 may select the angle θ1 with the largest intensity sum M1 and the angle θ3 with the second largest intensity sum M3 from the angles θ1 to 04, and a difference d between the intensity sum M1 and the intensity sum M3 needs to be less than the threshold (for example, if the threshold is set to be M3, the difference d needs to be less than M3). The processor 110 may obtain the intra mode of the target image block 300 according to the angle θ1, the angle θ3, and the lookup table, as shown in FIG. 7.

FIG. 7 illustrates a schematic diagram of calculating an intra mode according to an embodiment of the disclosure. In an embodiment, data S1 may include the angle θ1, data S3 may include the angle θ3, W1 is a weight corresponding to the angle θ1 (as shown in Formula (3)), and W3 is a weight corresponding to the angle θ3 (as shown in the Formula (4)). The processor 110 may calculate data S0 including an angle according to Formula (5), and select the intra mode corresponding to the data S0 from the lookup table as the intra mode of the target image block 300.

$$W 1 = \frac{M 1}{M 1 + M 3} \qquad ( 3 )$$

$$W 3 = \frac{M 3}{M 1 + M 3} \qquad ( 4 )$$

$$S 0 = S 1 \times W 1 + S 3 \times W 3 \qquad ( 5 )$$

In an embodiment, the processor 110 may respectively find the intra mode corresponding to the angle θ1 and the intra mode corresponding to the angle θ3 from the lookup table. The data S1 may include the intra mode corresponding to the angle θ1, the data S3 may include the intra mode corresponding to the angle θ3, W1 is the weight corresponding to the angle θ1, and W3 is the weight corresponding to the angle θ3. The processor 110 may calculate the data S0 according to Formula (5), and the data S0 may include the intra mode of the target image block 300.

Referring to FIG. 2 again, in step S203, the processor 110 may predict the target image block 300 according to the intra mode of the target image block 300, and the target image block 300 corresponds to an original image block. In step S204, the processor 110 may calculate residuals between the original image block and the predicted target image block 300, and transmit the residuals to the decoder through the transceiver 130.

FIG. 8 illustrates a flowchart of intra prediction adapted for a decoder according to an embodiment of the disclosure, and the flowchart may be implemented by the electronic device 100 as shown in FIG. 1. Step S801, step S802, and step S803 in FIG. 8 are respectively similar to step S201, step S202, and step S203 in FIG. 2, and therefore are not described again. In step S804, the processor 110 may receive the residuals corresponding to the target image block 300 through the transceiver 130, and reconstruct the original image block according to the residuals and the predicted target image block 300. For example, the processor 110 may sum the residuals and the predicted target image block 300 to reconstruct the original image block.

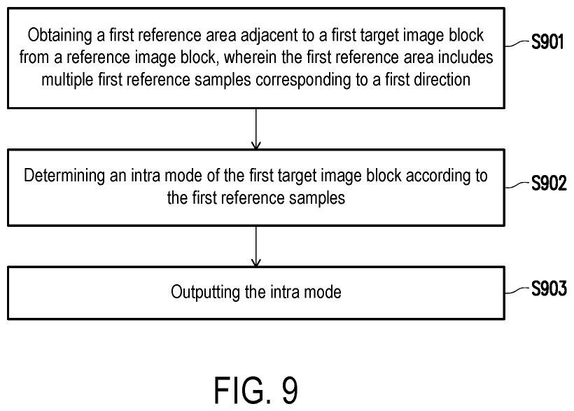

FIG. 9 illustrates a flowchart of a method of intra prediction according to an embodiment of the disclosure, and the method may be implemented by the electronic device 100 shown in FIG. 1. In step S901, a first reference area adjacent to a first target image block is obtained from a reference image block, and the first reference area includes multiple first reference samples corresponding to a first direction. In step S902, an intra mode of the first target image block is determined according to the first reference samples. In step S903, the intra mode is outputted.

In summary, the electronic device of the disclosure may obtain the reference samples from the reference image block adjacent to the target image block, and perform image processing for the target image block according to the reference samples. The electronic device may determine the intra mode of the target image block according to the reference samples based on a machine learning algorithm or a convolution operation. The method of intra prediction of the disclosure may be implemented in the encoder and the decoder, effectively reducing the complexity, energy consumption and size of the encoder, and improving the encoding speed. In addition, the disclosure may improve the compression rate of transmission data between the encoder and the decoder, thereby reducing the transmission time.

What is claimed is:

1. A method of intra prediction, comprising:
obtaining a first reference area adjacent to a first target image block from a reference image block, wherein the first reference area comprises a plurality of first reference samples corresponding to a first direction;
determining an intra mode of the first target image block according to the plurality of first reference samples; and
outputting the intra mode.

2. The method according to claim 1, wherein determining the intra mode of the first target image block according to the plurality of first reference samples comprises:
performing a convolution operation on the plurality of first reference samples according to a first convolution mask of a filter to obtain a first set;
performing a convolution operation on the plurality of first reference samples according to a second convolution mask of the filter to obtain a second set; and
determining the intra mode of the first target image block according to the first set and the second set.

3. The method according to claim 2, wherein determining the intra mode according to the first set and the second set comprises:
determining a plurality of intensity sums respectively corresponding to a plurality of angles according to the first set and the second set;
selecting at least one angle from the plurality of angles according to the plurality of intensity sums; and
obtaining the intra mode from a lookup table according to the at least one angle.

4. The method according to claim 3, wherein the first set comprises a first value, the second set comprises a second value corresponding to the first value, and determining the plurality of intensity sums respectively corresponding to the plurality of angles according to the first set and the second set comprises:
calculating a first intensity according to the first value and the second value;
determining that the first intensity corresponds to a first angle among the plurality of angles according to a ratio of the second value to the first value; and
in response to at least one intensity comprising the first intensity corresponding to the first angle, calculating a first intensity sum corresponding to the first angle according to the at least one intensity.

5. The method according to claim 3, wherein selecting the at least one angle from the plurality of angles according to the plurality of intensity sums comprises:
in response to at least one intensity sum corresponding to the at least one angle being greater than a second intensity sum corresponding to a second angle among the plurality of angles, selecting the at least one angle from the at least one angle and the second angle.

6. The method according to claim 3, wherein the at least one angle comprises a first angle corresponding to a first intensity sum and a second angle corresponding to a second intensity sum, and obtaining the intra mode from the lookup table according to the at least one angle comprises:
calculating a third angle according to a first weight corresponding to the first intensity sum, a second weight corresponding to the second intensity sum, the first angle, and the second angle; and
obtaining the intra mode from the lookup table according to the third angle.

7. The method according to claim 6, wherein a difference between the first intensity sum and the second intensity sum is less than a threshold.

8. The method according to claim 1, further comprising:
obtaining a second reference area adjacent to a second target image block from the reference image block, wherein the second reference area comprises a plurality of second reference samples corresponding to a second direction;
performing a convolution operation on the plurality of second reference samples according to a filter to obtain a plurality of intensities; and
dividing the second target image block according to the plurality of intensities to obtain the first target image block.

9. The method according to claim 8, wherein the plurality of intensities comprise a first intensity and a second intensity respectively corresponding to two adjacent reference samples, and dividing the second target image block according to the plurality of intensities to obtain the first target image block comprises:
in response to a difference between the first intensity and the second intensity being greater than a threshold, setting a split point according to the two adjacent reference samples; and
dividing the second target image block according to the split point to obtain the first target image block.

10. The method according to claim 2, wherein the filter comprises a directional feature detection filter.

11. The method according to claim 1, wherein the first reference area comprises a plurality of second reference samples corresponding to a second direction, and determining the intra mode of the first target image block comprises:
determining the intra mode of the first target image block according to the plurality of first reference samples and the plurality of second reference samples.

12. The method according to claim 1, further comprising:
predicting the first target image block according to the intra mode, wherein the first target image block corresponds to an original image block;
calculating residuals between the original image block and the first target image block predicted; and
transmitting the residuals.

13. The method according to claim 1, further comprising:
predicting the first target image block according to the intra mode;
receiving residuals corresponding to the first target image block; and
reconstructing an original image block according to the first target image block predicted and the residuals.

14. The method according to claim 1, further comprising:
in response to an image block having no adjacent reference samples, calculating an average intensity of the image block; and
transmitting the average intensity.

15. The method according to claim 1, further comprising:
receiving an average intensity corresponding to an image block; and
reconstructing the image block according to the average intensity, wherein the image block has no adjacent reference samples.

16. The method according to claim 1, wherein the reference image block and the first target image block are comprised in the same frame.

17. The method according to claim 1, wherein determining the intra mode of the first target image block according to the plurality of first reference samples comprises:
inputting the plurality of first reference samples to a machine learning model to obtain the intra mode.

18. The method according to claim 1, further comprising:
obtaining a second reference area adjacent to a second target image block from the reference image block, wherein the second reference area comprises a plurality of second reference samples corresponding to a second direction; and
inputting the plurality of second reference samples to a machine learning model to obtain the first target image block divided from the second target image block.

19. An electronic device of intra prediction, comprising:
a transceiver; and
a processor, coupled to the transceiver and configured for execution of:
obtaining a first reference area adjacent to a first target image block from a reference image block, wherein the first reference area comprises a plurality of first reference samples corresponding to a first direction;
determining an intra mode of the first target image block according to the plurality of first reference samples; and
outputting the intra mode through the transceiver.
